(19) United States
(12) Patent Application Publication
(10) Pub. No.: US 2009/0104946 A1
(43) Pub. Date: Apr. 23, 2009

(54) SYSTEMS AND METHODS FOR PROVIDING INTELLIGENT MOBILE COMMUNICATION ENDPOINTS

(75) Inventor: Prakash Khandourl, Freehold, NJ (US)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 11/877,327

(22) Filed: Oct. 23, 2007

(51) Int. Cl. H04M 1/00; H04B 1/38

(52) U.S. Cl. 455/569.2; 455/554.2; 455/569.1

(57) ABSTRACT

A communications network is provided. The network preferably includes a Voice over Internet Protocol (VoIP) wired network and a mobile phone. The mobile phone preferably includes a first radio control code for communicating with a wireless mobile phone network and a second radio control code for communicating over the VoIP network. The mobile phone includes a speaker and a microphone. The network may operate in a state of communication such that the microphone of the mobile phone is operational to receive audio signals and transmit the audio signals over the VoIP and the speaker of the mobile phone is non-operational.

### FIELD OF TECHNOLOGY

This invention relates to techniques used to dynamically adapt a mobile phone to different environments. More particularly this invention relates to allowing a single mobile phone device to function in response to different network connections.

### BACKGROUND OF THE INVENTION

For the purpose of this application, a mobile phone may be referred to generally as an “endpoint”. The term endpoint as used herein describes a mobile phone because the mobile phone is the final destination of communication and, as such, forms the endpoint of a communication system. Additionally, endpoint as used herein can be understood to describe any final, or substantially final, destination of a communication system. It would be desirable to merge all the telephone technology, including but not limited to cellular communication systems, home communication systems, vehicle-based communication systems, VoIP (Voice over Internet Protocol Systems), Wi-Fi (wireless broadband technology) and/or BT (BlueTooth) (references herein to Wi-Fi/Blue Tooth may be understood for the purposes of this application to refer to a system that implements either Wi-Fi or BlueTooth or some combination of both) and/or other suitable communications systems at a single endpoint such as a mobile phone.

### SUMMARY OF THE INVENTION

A system and/or method for dynamically adapting the operational characteristics of a mobile phone in response to selected stimuli, substantially as shown in and/or described in connection with at least one of the figures, as set forth more completely in the claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of a conventional mobile phone;

FIG. 2 shows a stand-alone (or other suitable system) pod speakerphone and a mobile phone according to the invention;

FIG. 3 shows an embodiment of a network according to the invention for use within a home setting;

FIG. 4 shows an embodiment of the invention as implemented in an automobile;

FIG. 5 shows a hybrid network according to the invention;

FIG. 6 shows the basic audio building blocks of a conventional VoIP endpoint according to the invention;

FIG. 7 shows the basic audio building blocks for an access point which will send voice packets from the VoIP network to the mobile phone via a Wi-Fi/BT interface;

FIG. 8 shows basic audio building blocks of an intelligent endpoint according to the invention, and an interface associated therewith;

FIG. 9 shows basic audio building blocks of a POD speakerphone according to the invention;

FIG. 10 shows 3-way conferencing using endpoints according to the invention; and

FIG. 11 shows a schematic diagram of an illustrative single or multi-chip module of this invention in a data processing system.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

One method of implementing the invention may include integrating wireless and landline technologies on a single mobile phone platform. Such a platform may include a single integrated circuit, or a single device.

Furthermore, such a merged technology involving various telephone technologies (Cellular, Wi-Fi+BT and VoIP) for home and business applications may also provide the most cost effective technology from the end user's point of view.

In addition, a need exists for intelligent endpoints—endpoints that could dynamically switch between different communications systems. Such endpoints could be used as voice and data devices using wireless and/or landline networks. Such endpoints could provide the best call quality and applications on demand at the minimum cost. It would be desirable to implement such an intelligent endpoint on a single “intelligent” chip.

Furthermore, endpoints may be used by end users as true multimedia devices and, accordingly, users typically expect best in class services all the time especially if they are using these devices while at home or work. Thus, it would be desirable to maintain the high level of service provided by endpoints while further adapting the additional endpoints for use with changing environments.

Mobile phone antennas typically are used by mobile phones to receive and transmit data. The data may include frame data, encoding data and other relevant data. These data are typically sent using radio signals. These data typically control the radio hardware in the phone and are the vehicles by which the phone talks to the base stations.

Generally, this data is received and transmitted using typical hardware and specialized software to convert the data into a radio signal and transmit the data as a radio signal.

Certain embodiments of the invention relate to using Wi-Fi/BT technology for routing calls from the mobile phone to the VoIP network in a user's home even without involving a service provider. Such an embodiment may be implemented by providing the mobile phone with “cordless” phone capabilities that allow the mobile phone to switch from functioning as a mobile phone to functioning as a cordless phone using Wi-Fi/BT technology. Additionally, in such an embodiment of the invention that implemented the mobile phone as a cordless phone while in a user's home or other environment.

In an additional embodiment of such an implementation according to the invention, if the user was actively on a phone call using the cellular network provider at the time the user entered the landline (which may be implemented using a VoIP network) Wi-Fi/BT environment then the phone control according to the invention may let the call progress using the cellular network so as not to lose the call. Such an embodiment may avoid switch involvement in managing the endpoint's states and resolve the billing issues due to different service providers.

Additional embodiments of the invention may not require modification of cellular or VoIP standards. Rather the existing cellular standard and VoIP standard may be used as is and the Wi-Fi/BT technologies may be implemented to change the routing of calls from the cellular network to the local VoIP network while users are at home or at work. More specifically, when a user of an intelligent endpoint according to the invention desired to make a call, the mobile phone could route the call using the Wi-Fi/BT over the VoIP network in the home or workplace. When the user received the call over the VoIP network, the call could be received at the mobile phone using the Wi-Fi/BT system. Finally, when the user received a call over the cellular network, the call could be received over the cellular network, or, alternatively, could be switched through the VoIP network and then transmitted to the mobile phone using the Wi-Fi/BT system.

Such embodiments of the invention that combine landline and wireless technologies may also improve communication security, call control and quality. For example, the VoIP system requires a constant power source to function. By combining the technologies described above into a single endpoint, the invention could improve the overall call security especially during a power failure. Thus, when the power to the VoIP system failed, the call could be switched to the cellular network thereby maintaining the integrity of the call. Also the service providers could allocate bandwidth depending on the effect of the invention on network traffic and the quality of service agreement currently in place.

With the proposed approach, users can make use of the WB (Wide Band which provides about 16 Kilobits per second which allows for relatively clear voice transmission) telephony (as opposed to the Narrow Band for mobile communications which provides PSTN type voice quality) while at home or at work without paying extra. For example, a special radio control code could be implemented according to the invention and a unified coding scheme could be used to maintain superior call quality independent of changes to local environment. The unified coding scheme could preferably improve communication quality when the conditions allowed—i.e., the coding scheme could cause the phone to switch to the VoIP system, which allows Wide Band communication when the mobile phone detected that it was within a certain proximity of an accessible VoIP system.

Additional embodiments of endpoints according to the invention may be adapted to run various applications. In order to reduce the power and memory constraints on the endpoints, the network be required to download applications to the endpoints on demand. Furthermore, service providers may generate revenue from the services associated with downloading and maintaining the applications while letting the endpoints negotiate call quality. The network may act as an information pipe between such intelligent endpoints.

With respect to the architecture of the phone according to the invention, the basic phone may require a ROM MASK in order to reduce cost and application software that will serve as a platform to download applications on demand. In certain embodiments of the invention, various ASICS (Application Specific Integrated Circuits) may be produced and tailored to individual needs of mobile phone providers. Multiple ASICS may be provided to fit general classes of consumer needs with respect to application support. However, the basic phone architecture will typically not change and a manufacturer could produce similar devices with different speed and memory configurations. This will reduce the overall phone cost.

The cost of the phone may be determined by the capability of the application processor, the requirement for additional processors to support a greater number and complexity of applications, the battery power, display size and quality, flash memory and acoustics.

The endpoint according to the invention may also act as an information pipe which could require basic intelligence at the endpoints. This added capacity at the endpoint may provide better network monitoring during the live calls based on the information provided by the endpoints and endpoints supporting application on demand. The network can monitor the call quality from the information provided by these endpoints and, in based on the monitoring, allocate the resources accordingly.

In certain embodiments of the phone, the basic telephone intelligence—i.e., the portion of the system that allows the mobile phone to detect and switch between different environments—would be at the endpoints. In such an embodiment of the invention, there may be two software cores: one for basic telephony and one for downloading applications. Other embodiments are also possible. The basic telephony software may be implemented in the ROM MASK, preferably customized as per general class of application power request, and the application processor(s) could be implemented in a flash part with the capability to download and/or store downloadable applications.

In one embodiment of the invention, Wi-Fi/BT may be used for combining cellular and VoIP in a mobile phone according to the invention. Specifically, the audio control code in the mobile phone can be use to control cellular radio and route the calls from the cellular network to the VoIP network when the users enters the home environment or the work environment.

Enterprises, businesses or other self-contained entities may preferably utilize Wi-Fi/BT technology for in-building or other suitable intra-entity communications. Thus, software could be developed for use by entities that could be used to route the calls and control the audio mode on the fly—i.e., in response to dynamically changing environments or location with respect to static environments. The software could provide endpoints to act as a cordless phone while at home or at work.

This will help reduce cost by providing a mobile phone that can be used as cordless/VoIP phone while a user is at work or home.

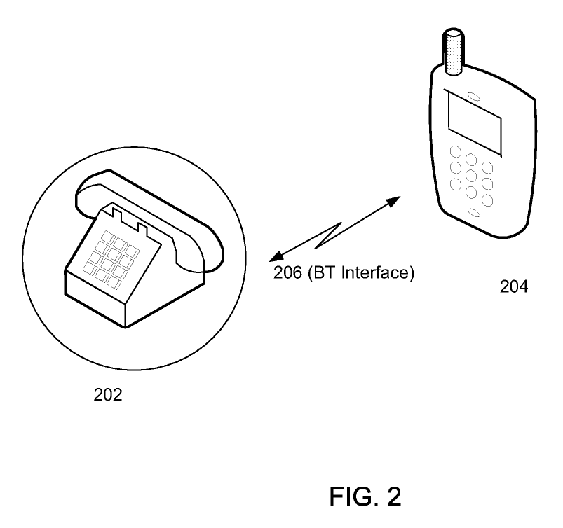

Wi-Fi/BT in the endpoints can also be used according to the invention for shuffled calls (routing audio between the endpoints without involving a central hub or switch). This will be useful for in-building application or during conferencing. This embodiment is discussed in more detail below with respect to FIGS. 2-6.

As described above, the phone software may be divided into two cores: the basic phone application software and the specific application on demand software. The application software may be configured to support application on demand software such as speech codec, 3-way conferencing, music, video and other suitable downloadable software. In alternative embodiments of the invention, the downloadable application portion of the software may be implemented external to the phone and hence the ROM based portion of the mobile phone may no longer be used for downloading and supporting applications on demand.

Furthermore, intelligent endpoints according to the invention may be useful for emergency services, especially when a VoIP network is down. Hence, it will enhance the capability of the phone system, improve the network security and increase reliability. The mobile phone according to the invention could be further enhanced by integrating GPS for E-911 phone calls.

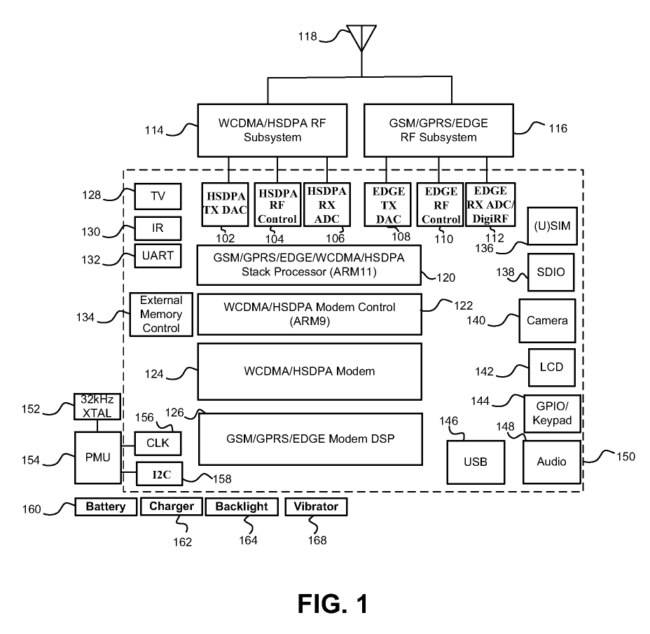

FIG. 1 shows a schematic diagram of a mobile phone 150 that could be used for systems and methods according to the invention. Mobile phone 150 preferably include components HSDPA Transmitter DAC 102, HSDPA RF Control 104, HSDPA RX ADC 106, EDGE¹ TX DAC 108, EDGE RF Control 110, and EDG RX ADC/DigiRF 112 (each of which forms a portion the hardware for converting the digital signal from the modem to an analog RF signal for the antenna and vice-versa). WCDMA²/HSDPA RF subsystem 114, GSM/GPRS/EDGE subsystem 116, and antenna 118 are for establishing a connection between the phone and the cell. ¹Enhanced Data rates for Global Evolution—EDGE uses the same spectrum allocated for GSM900, GSM1800 and GSM1900 operation. Instead of employing GMSK (Gaussian Minimum Shift Keying) EDGE uses 8PSK (8 Phase Shift Keying) producing a 3-bit word for every change in carrier phase. This effectively triples the data rate offered by GSM. The use of EDGE enables GSM to increase the data rates that can be offered to users of the GSM spectrum.²WCDMA—Wideband Code Division Multiple Access—An ITU (International Telecommunications Union) standard derived from CDMA (Code Division Multiple Access) technology.

Components GSM/GPRS/EDGE/WCDMA/HSDPA Stack Processor (ARM11) 120 (which is the baseband processor for the phone), WCDMA/HSDPA Modem control (ARM9) 122, WCDMA/HSDPA Modem 124 and GSM/GPRS/EDGE Modem DSP 126 are the core processing logic and further contain relevant mobile phone communications protocols. Processor 120 may preferably support the two-core software solution for providing intelligent endpoints and supporting downloadable applications.

Finally, components TV 128, IR (Infrared) 130, UART 132 (Universal Asynchronous Receiver/Transmitter—i.e., hardware that translates data between parallel and serial interfaces) external memory control 134, (U)SIM³ 136, SDIO (Secure Digital Input/Output (SDIO) is a standard for devices that feature interchangeable memory options) 138, camera 140, LCD 142, GPIO/Keypad 144, USB interface 146, and audio 148 are all for connections to phone peripherals. 32 kHz XTAL 152 (an oscillator that uses a quartz crystal to generate a frequency) is coupled to PMU (Power Management Unit) which is, in turn, coupled to CLK (Clock) 156 and 12C Bus 158. Furthermore, battery 160, charger 162, backlight 164, and vibrator 168 (or other tactile feedback) are shown schematically for further illustration. ³USIM—UMTS Subscriber Identity Module Usually referred to as a SIM card, the USIM (UMTS Subscriber Identity Module) is the user subscription to the UMTS mobile network. The USIM contains relevant information that enables access onto the subscribed operator's network.

FIG. 2 shows a VoIP (or other suitable system) pod speakerphone 202 having Wi-Fi and/or BT capability and a mobile phone 204 according to the invention. The VoIP PCM signal from the VoIP access point could be routed to the cellular endpoint via the Wi-Fi/BT interface. Thus, the audio processing will only be done at the cellular endpoint with appropriate jitter buffer on each audio path in order to avoid or at least reduce the delay variations. Speakerphone 202, which may be referred to by the terminology “pod speakerphone” herein may be understood to be a central connection point for the endpoint to the VoIP system. Speakerphone 202 may preferably be in communication with mobile phone 204 via Wi-Fi/BT interface 206. A stand alone wireless speakerphone can be designed with appropriate Wi-Fi/BT interface as is known in the art.

POD speakerphone 202, which, in certain embodiments, could include basic audio processing blocks, could also directly receive PCM (Pulse Code Modulation) audio samples either from the VoIP access point or from the mobile endpoints via Wi-Fi/BT radio.

Speakerphone 202 could be included with the latest audio technologies that include optimally available acoustics and microphone technologies. Such a solution may be implemented in business environments or other environments that include multiple users that require speakerphone access. Thus using cell phone radio or VoIP connections vis Wi-Fi/BT to POS (Point of Service) speakerphone audio could provide a user the “best in class” conferencing or a “mobile” access to a speakerphone.

In one embodiment of the system shown in FIG. 2, each mobile phone 204 user can access the Pod speaker phone line when the user is in the same location—i.e., within Wi-Fi/BT access—of speakerphone 202. Thus, users could use pod phone 202 for conferencing purposes even though the user is not located within direct acoustic proximity of the phone but rather only within Wi-Fi accessibility (up to about 100 meters) and/or BT accessibility (up to about 30-40 feet).

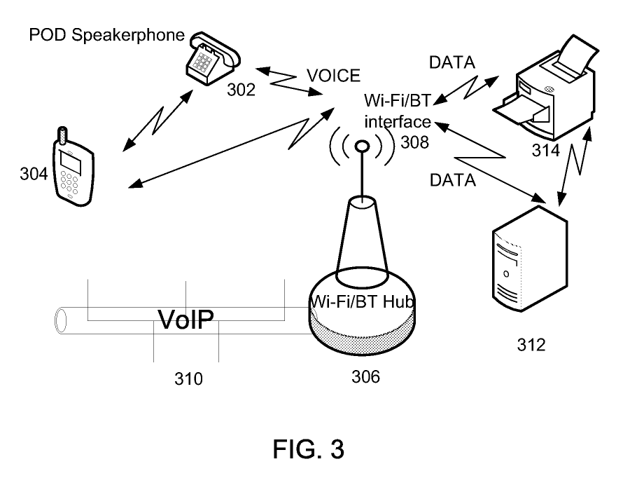

FIG. 3 shows an embodiment of a network according to the invention for use within a home setting. FIG. 3 preferably shows a pod speakerphone 302 and a mobile phone 304 which can act as a cordless phone, according to the invention. FIG. 3 also shows a Wi-Fi/BT hub 306 which may preferably be connected to a wideband VoIP network 31 0. In one embodiment of the invention, a call can be sent from mobile phone 304 via Wi-Fi/BT interface 308 using hub 306 and VoIP network 310 or received via mobile phone 304 and routed to VoIP network 310.

Also shown in FIG. 3 are computer 312 and printer 314. Hub 306 and interface 308 could also provide a wireless network within the home to send and/or receive data to/from computer 312 and to/from printer 314 as needed. Thus, a network according to the invention could truly provide a relatively comprehensive solution inside a home using intelligent endpoints. In the embodiment shown in FIG. 3, phone 304 could preferably control the operation of hub 306 instead of controlling the operation of pod speakerphone 302.

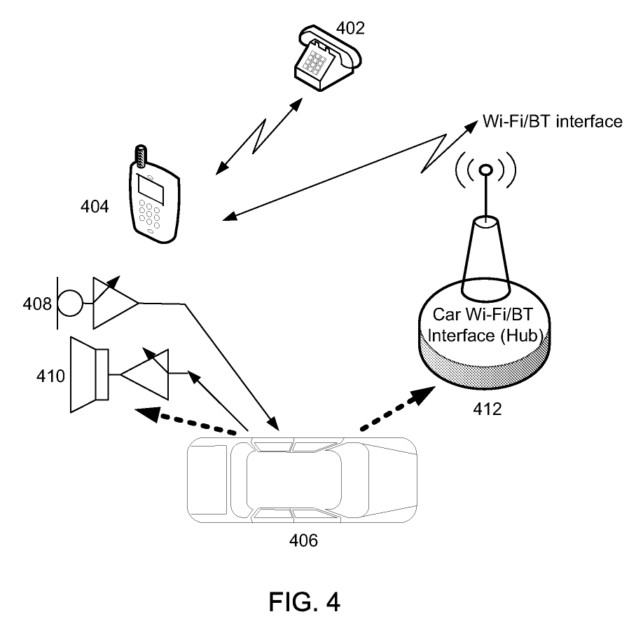

FIG. 4 shows an embodiment of the invention as implemented in an automobile 406. FIG. 4 includes pod speakerphone 402, mobile phone (endpoint) 404, automobile 406, automobile microphone 408, automobile speakerphone 410, and automobile Wi-Fi/BT Interface (Hub) 412. In such an embodiment, there is no need to have a dedicated cellular radio network that provides cellular service to the automobile 406. Rather, mobile phone 404 could be the only networked device.

In some embodiments of the invention, cellular phone 404 along with Wi-Fi/BT interface 412 could be used to transfer audio to the automobile's transducers for use in the automobile microphone 408 and the automobile speakers 410. Thus, one of the automobile speaker transducers can be used as a receiver for signals from mobile phone 404 and either a BlueTooth headset microphone or wired microphone could be use for uplink purposes—i.e., to allow passengers to talk into automobile's communication system and to be transferred to the network via interface 412. Alternatively, sophisticated microphone array technologies (not shown) which could be used for uplink. Such an embodiment may preferably conserve power in mobile phone 404 because the mobile phone may be used only for receiving and transmitting signals but not for providing audio through the mobile phone speakers. Rather, the audio would be transmitted to the automobile speakers 410 which possess a relatively constantly replenished source of power.

In certain embodiments, a user could also use mobile phone 404 via Wi-Fi/BT interface 412 to program automobile 406, lock automobile 406 or talk to automobile 406 as needed. Thus, phone 404 may preferably control the operation of hub 412 in automobile (instead of controlling the hub in the home as shown in FIG. 3.)

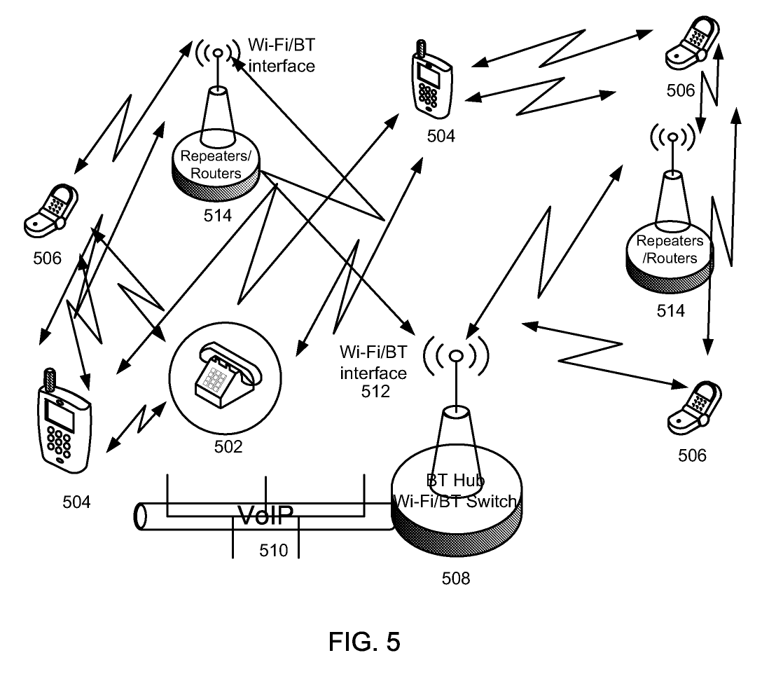

FIG. 5 shows a hybrid network 500 according to the invention. Such a network may preferably be implemented in a single building or group of buildings that are located near to one another. Network 500 preferably includes system mobile phones 504 that can work directly with pod speakerphone 502. Network 500 may also include mobile phones 506. Network 500 may, at least in part, be coordinated by BT Hub Wi-Fi/BT Switch 508. Switch 508 is preferably connected to VoIP network 510. VoIP network may permit switch 508 to operate at relatively wide bandwidth—i.e., in the range of 16 Kilobits per second—and provide relatively clear voice signals over the network.

Also shown in FIG. 5 are the Wi-Fi/BT Interface 512, repeater/routers 514 for strengthening the signal where necessary and routing communications from the various intelligent endpoints.

Preferably, all the outside calls within the building are routed to the VoIP network 510. In one embodiment of the invention shown in FIG. 5, mobile phones 504 and 506 may act as cordless phones with respect to communications routed through interface 512 by repeaters/routers 514. Interface 512 may also be directly provided by hub/switch 508. Furthermore, any mobile phone 504/506 could route a call to local pod speakerphone 502 for conferencing using speakerphone 502 as the base. In yet another embodiment, a user could talk from one phone 504 to one another phone 506 without involving hub/switch 508. In such an embodiment, one phone could preferably converse with another phone in the building in a Wide Band fashion without using the Internet. In one particular embodiment, this could be implemented when each of the phones preferably has separate IP addresses. Each endpoint could store a fixed set routing numbers which could be dynamically assigned to the endpoints during negotiation and eventually could be used to route calls between the endpoints. During the conferencing one of the endpoints could act as a node.

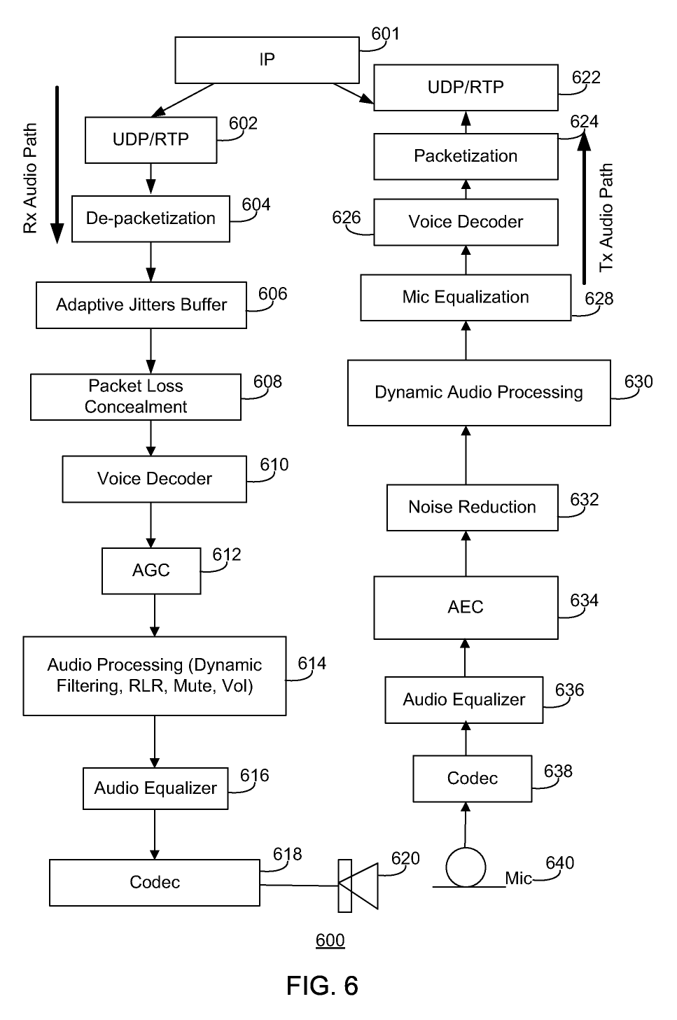

FIGS. 6-9 show how the audio can be routed to and from the cellular endpoints from and to a pod speakerphone or a stand-alone VoIP network using a Wi-Fi/BT interface. It should be understood that the following implementations and associated building blocks are merely exemplary and other configurations, implementations and building blocks are also possible and within the scope of the invention.

FIG. 6 shows the basic audio building blocks of a conventional VoIP endpoint according to the invention. FIG. 6 also includes an IP endpoint 601. Basic building blocks along the Rx (receiver) audio path include a UDP/RTP (user datagram protocol/real-time transport protocol) block 602, a depacketization block 604, an adaptive jitters buffer 606, a packet loss concealment block 608, a voice decoder 610, an AGC (Automatic Gain Control) 612, an audio processing block for dynamic filtering, RLR, Mute, Volume) 614, an Audio equalizer 616, a Codec 618, and a speaker 620. Basic building blocks along the Tx (transmitter) audio path include microphone 640, Codec 638, audio equalizer block 636, AEC (acoustic echo cancellation) 634, a noise reduction block 632, a dynamic audio processing block 630, microphone equalization 628, voice decoder 626, packetization 624, and UDP/RTP.

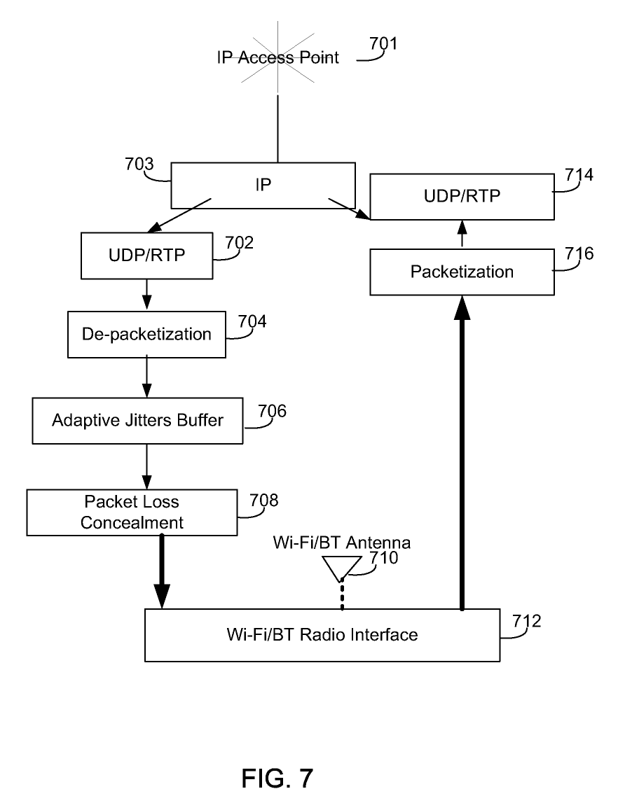

FIG. 7 shows the basic audio building blocks for an access point which will send voice packets from the VoIP network to the mobile phone via a Wi-Fi/BT interface. There may preferably be no audio processing done at the IP interface and preferably all the audio processing can be done either at the POD speakerphone, which, in such an embodiment of the invention may also act as an endpoint (albeit a non-mobile one) according to the invention, and/or at the cellular endpoints. In such embodiments, a user could select where they would like audio to be routed using such intelligent endpoints according to the invention. FIG. 7 includes IP Access Point 701, IP base station 703, UDP/RTP block 702, de-packetization block 704, an adaptive jitters buffer 706, a packet loss concealment block 708, a Wi-Fi/BT Antenna 710, a Wi-Fi/BT radio interface 712, a packetization block 716 and a UDP/RTP 714.

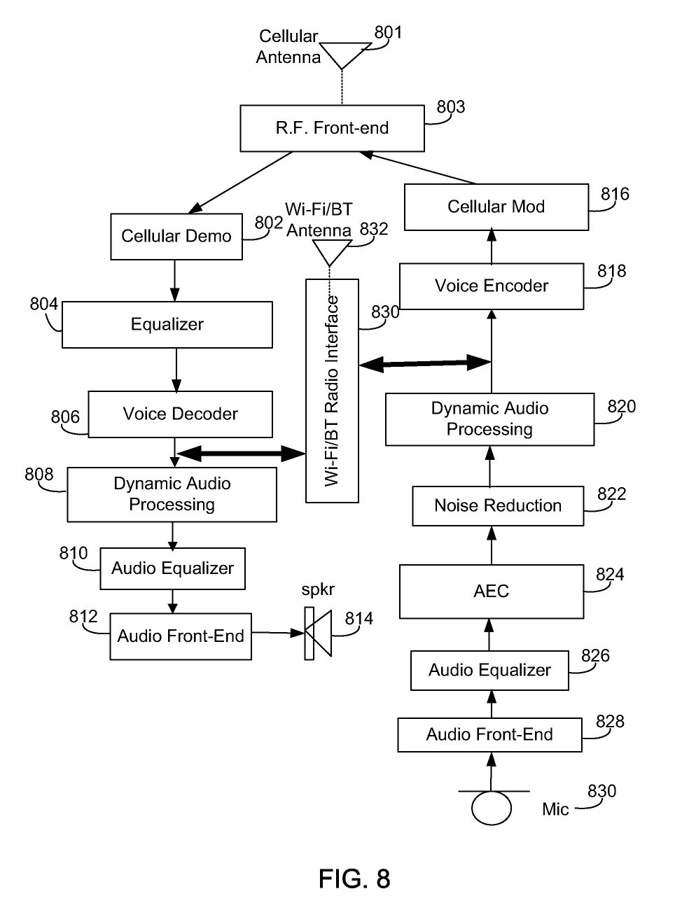

FIG. 8 shows basic audio building blocks of an intelligent endpoint according to the invention, and an interface associated therewith. The building blocks include a cellular antenna 801 and a Radio Frequency (R.F.) front end 803. On the receiving side, the building blocks include a cellular demodulator 802, an equalizer 804, a voice decoder 806, an equalizer 804, a voice decoder 806, a dynamic audio processing block 808, an audio equalizer 810, an audio front-end block 812 and a speaker 814. On the transmitting side, the building blocks include an audio front-end 828, an audio equalizer 826, and AEC 824, a noise reduction block 822, a dynamic audio processing block 820, a voice encoder 818 and a cellular modulator 816.

The Wi-Fi Radio Interface 830, using Wi-Fi/BT Antenna 832, which can be implemented in a mobile phone, may preferably interface on the receiving side of the mobile phone signal propagation between voice decoder 806 and dynamic audio processing block 808. Wi-Fi/BT Radio Interface 830 may preferably interface on the transmitting side of the mobile phone signal propagation between voice encoder 818 and dynamic audio processing block 820.

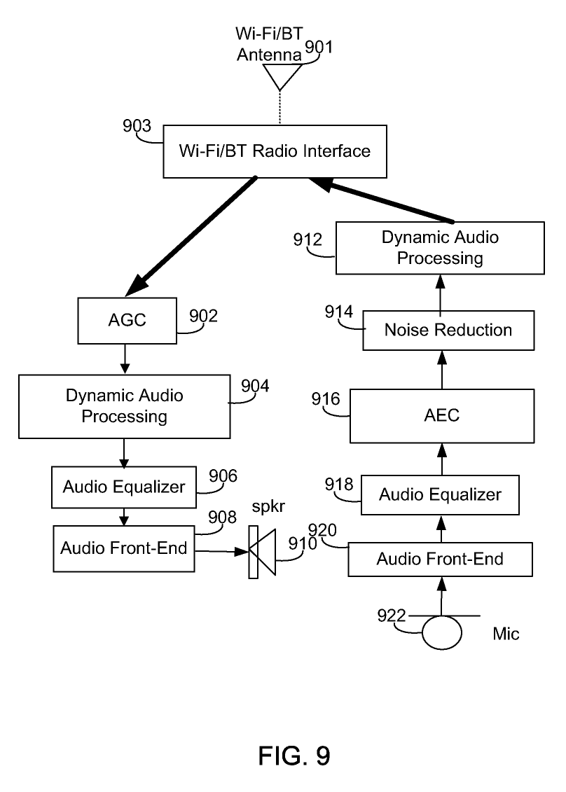

FIG. 9 shows basic audio building blocks of a POD speakerphone according to the invention. The building blocks include along the receiving end a Wi-Fi/Antenna 901, a Wi-Fi/BT radio interface 903, an automatic gain control block 902, a dynamic audio processing block 904, an audio equalizer 906, an audio front end 908, and a speaker 910. The building blocks include along the transmitting end a microphone 922, an audio front-end 920, and audio equalizer 918, and AEC 916, a noise reduction block 914 and a dynamic audio processing block 912.

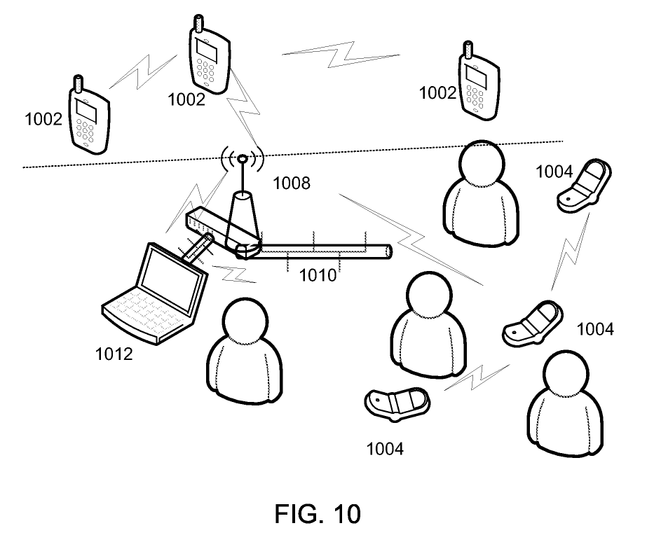

FIG. 10 shows an embodiment of the invention including 3-way conferencing at the endpoints. In this embodiment, each end point can act as a node for other endpoints during the conferencing. Basically, the embodiment shows a mesh network of 3-way conferencing systems. The embodiment of the invention in FIG. 10 includes intelligent endpoints 1002 and 1004, hub 1008, VoIP network connection 1010, and coordinating computer 1012.

In the embodiment shown in FIG. 10, preferably each of endpoints 1002 and 1004 could support group conferencing. The user could use BlueTooth devices as UL (Uplink—i.e., microphone transmission device) and one of the mobile phone speaker can be use as common DL (Downlink—i.e., speaker transmission device). In such an embodiment, the power for using the speakers in the remaining endpoints could preferably be saved.

This entire conferencing mesh could preferably be implementing using the local Wi-Fi/BT network. Such an implementation as shown in FIG. 10 may insure no extra cost—such as additional conference call set-up charges or an additional conference call vendor—to the end user. This implementation may reduce trans-coding and other signal loss due to traditional conferencing systems.

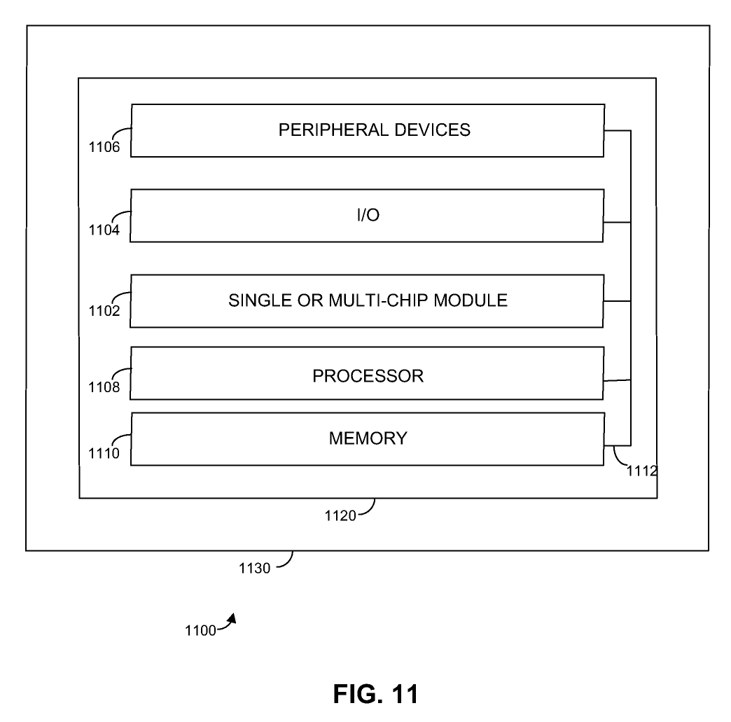

FIG. 11 shows a single or multi-chip module 1102 according to the invention, which can be one or more integrated circuits, in an illustrative data processing system 1100 according to the invention. Data processing system 1100 may include one or more of the following components: I/O circuitry 1104, peripheral devices 1106, a processor 1108 and memory 1110. These components are coupled together by a system bus or other interconnections 1112 and are populated on a circuit board 1120 which is contained in an end-user system 1130. System 1100 may be configured for use in a mobile phone or other intelligent endpoint according to the invention. It should be noted that system 1100 is only exemplary, and that the true scope and spirit of the invention should be indicated by the following claims.

Thus, systems and methods for providing intelligent endpoints have been described. Persons skilled in the art will appreciate that the present invention can be practiced by other than the described embodiments, which are presented for purposes of illustration rather than of limitation, and the present invention is limited only by the claims which follow.

What is claimed is:

1. A communications network comprising:
a Voice over Internet Protocol (VoIP) wired network;
a mobile phone comprising a first radio control code for communicating with a wireless mobile phone network, and a second radio control code for communicating over the VoIP network, the mobile phone comprising a speaker and a microphone; and
a state of communication wherein: the microphone of the mobile phone is operational to receive audio signals, the mobile phone is operational to transmit audio signals over the VoIP, and the speaker of the mobile phone is non-operational.

2. The network of claim 1 further comprising a speakerphone in wired communication with the VoIP network.

3. The network of claim 1 wherein the mobile phone includes a first instruction to switch from the first radio control code to the second radio control code when the mobile phone enters a predetermined distance from the VoIP network.

4. The network of claim 1 wherein the first radio control code comprises a second instruction that maintains the mobile phone on a call using the wireless mobile phone network when, at the time the mobile phone enters an operational proximity of the wireless broadband technology interface, the mobile phone is currently on a call using the wireless mobile phone network.

5. A digital processing system comprising:
processing circuitry;
a memory coupled to said processing circuitry; and
apparatus that stores the first radio control code as defined in claim 1, said apparatus being coupled to the processing circuitry and the memory.

6. A printed circuit board on which is mounted apparatus as defined in claim

7. The printed circuit board defined in claim 6 further comprising a memory mounted on the printed circuit board and coupled to the apparatus.

8. The printed circuit board defined in claim 6 further comprising processing circuitry mounted on the printed circuit board and coupled to the apparatus.

9. The network of claim 1, the mobile phone further comprising a scalable architecture for downloading and updating software applications for use on the mobile phone.

10. A method for communicating comprising:
using a mobile phone to communicate via a mobile phone network; and
when the mobile phone is located within a predetermined distance of an interface with a VoIP network, activating a radio control code in the mobile phone that switches the mobile phone communication to communicate wirelessly with the VoIP network.

11. The method of claim 10 further comprising, when the mobile phone is communicating wirelessly with the VoIP network, selectively terminating the operation of the speaker of the mobile phone.

12. The method of claim 10 further comprising maintaining the mobile phone on a call using the wireless mobile phone network when, at the time the mobile phone enters an operational proximity of the wireless broadband technology interface, the mobile phone is currently on a call using the wireless mobile phone network.

13. A communications network comprising:
a Voice over Internet Protocol (VoIP) wired network;
a plurality of mobile phones, each of the plurality of mobile phones comprising a first radio control code for communicating with a wireless mobile phone network, a second radio control code for communicating over the VoIP network, and a third radio control code for communicating with another of the plurality of mobile phones, each of the plurality of mobile phones comprising a speaker and a microphone; and
a state of communication using the VoIP network wherein the microphone of at least one of the plurality of mobile phones is operational to receive audio signals and transmit the audio signals over the VoIP and the speaker of the mobile phone is non-operational.

14. The network of claim 13 further comprising a speakerphone in wired communication with the VoIP network.

15. The network of claim 13 wherein the mobile phone includes a first instruction to switch from the first radio control code to the second radio control code when the mobile phone enters a predetermined distance from the VoIP network.

16. The network of claim 13 wherein the first radio control code comprises a second instruction that maintains the mobile phone on a call using the wireless mobile phone network when, at the time the mobile phone enters an operational proximity of the wireless broadband technology interface, the mobile phone is currently on a call using the wireless mobile phone network.

17. An automobile comprising:
a mobile communications system comprising:
a microphone for receiving audio signals; and
a plurality of speakers for providing audio signals;
an interface that wirelessly couples the mobile communications system to a mobile communications network; and
a state of communication using the interface wherein the microphone is non-operational and the speakers are operational to provide audio signals received over the mobile communications network.

18. The automobile of claim 17 wherein the automobile comprises a wireless broadband technology interface (Wi-Fi) that communicates with the mobile phone.

19. The automobile of claim 17 wherein the automobile comprises a BlueTooth technology interface (BT) that communicates with the mobile phone.
